(19) United States
(12) Patent Application Publication
(10) Pub. No.: US 2007/0228116 A1
(43) Pub. Date: Oct. 4, 2007

(54) Method for adhering a heat pipe wall and a wick structure

(75) Inventor: Hul-Chun Hsu, Taichung City (TW)

Correspondence Address: HDSL, 4331 STEVENS BATTLE LANE, FAIRFAX, VA, 22033, US

(73) Assignee: JAFFE LIMITED

(21) Appl. No.: 11/393,878

(22) Filed: Mar. 31, 2006

(51) Int. Cl. B23K 3/06; B23Q 5/22

(52) U.S. Cl. 228/244

(57) ABSTRACT

A method for adhering a heat pipe wall and a wick structure includes the steps of preparing a hollow heat pipe body; placing at least one layer of wick structure at an internal wall of the pipe body; putting an appropriate quantity of metal powder in the pipe body so that the metal powder is attached to the wick structure; sintering the metal powder to be used as an adhesive for the pipe body and the wick structure, so that the wick structure is adhered onto the internal wall of the pipe body by the metal powder, and fibers of the wick structure are cohered with each other by the metal powder to enhance the effect of adhering the wick structure onto the pipe wall without affecting the original capillary attraction and transmission of the wick structure.

### BACKGROUND OF THE INVENTION

1. Field of the Invention

The present invention relates to a method for adhering a heat pipe wall and a wick structure, and more particularly to a method that sinters a metal powder and uses the sintered metal power as an adhesive for a heat pipe wall and a wick structure to enhance the effect of attaching the wick structure onto the pipe wall.

2. Description of Prior Art

Since a heat pipe has the features of a high thermal conducting capability, a quick thermal conduction, a high conductivity, a light weight, free of passive components, a simple structure, and multipurpose, therefore the heat pipe can conduct a great deal of heat without consuming much electric power and it is applicable for the heat dissipation required for electronic products. In general, a heat pipe wall usually installs a wick structure, and the wick structure is comprised of meshes or fibers having a capillary effect, so that the capillary effect of the wick structure can be used for transmitting a working fluid in a heat pipe.

The process of forming the wick structure on the heat pipe in the past usually has to go through a sintering process to adhere the wick structure onto an internal wall of a pipe body of the heat pipe, but the adhering effect is poor since the materials of the wick structure comprised of meshes or fibers are softened and then the wick structure is adhered onto the internal wall of a pipe body during the sintering process, and thus the wick structure may come off easily and seriously affect the transmission of the working fluid, and the wick structure cannot be attached onto the pipe wall by an adhesive such as a solder paste. For the worst cases, the capillary attraction and transmission may be disabled.

### SUMMARY OF THE INVENTION

In view of the foregoing shortcomings of the prior art, the inventor of the present invention based on years of experience in the related industry to conduct experiments and modifications, and finally designed a method for adhering a heat pipe wall and a wick structure in accordance with the present invention to overcome the shortcomings of the prior art.

The present invention is to overcome the shortcomings of the prior art by providing a method for adhering a heat pipe wall and a wick structure that sinters a metal powder and uses the sintered metal powder as an adhesive for the heat pipe wall and wick structure to enhance the effect of attaching the wick structure onto the pipe wall, without affecting the original capillary attraction and transmission of the wick structure.

The present invention provides a method for adhering a heat pipe wall and a wick structure comprising the steps of:

(a) preparing a hollow heat pipe body, and placing at least one layer of flexible wick structure at an internal wall of the pipe body;

(b) putting a metal powder into the pipe body, so that the metal powder is attached into the wick structure; and

(c) sintering the metal powder to be used as an adhesive for the pipe body and the wick structure, such that the wick structure is adhered onto an internal wall of the pipe body by the metal powder, and the fibers of the wick structure are cohered with each other by the metal powder.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a flow chart of the present invention; and

FIG. 2 is an enlarged view of a wick structure being adhered with a heat pipe wall according to the present invention.

### DETAILED DESCRIPTION OF THE INVENTION

The technical characteristics, features and advantages of the present invention will become apparent in the following detailed description of the preferred embodiments with reference to the accompanying drawings.

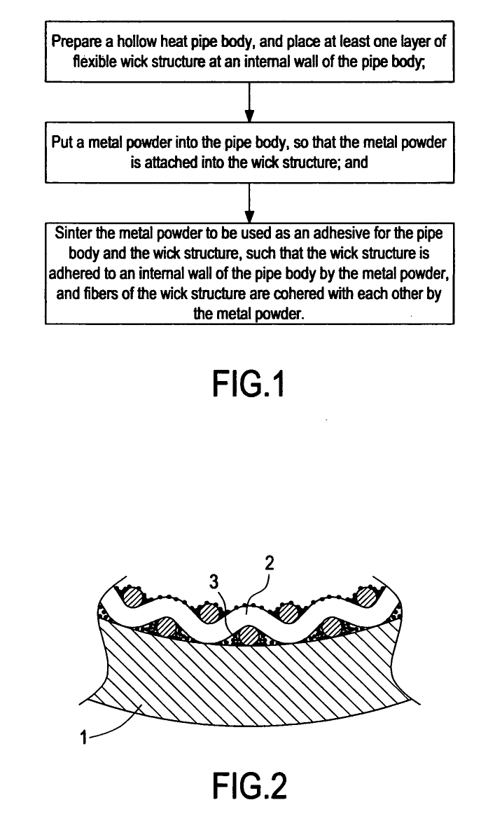

Referring to FIG. 1 for the flow chart of the present invention, the method for adhering a heat pipe wall and a wick structure in accordance with the present invention comprises the steps of:

(a) preparing a hollow heat pipe body, and putting at least one layer of flexible wick structure at an internal wall of the pipe body; wherein the flexible wick structure is comprised of meshes or fibers, and the flexible wick structure is coiled to a size with a diameter that can be put into the heat pipe body, and the wick structure is put axially into an opening end of the pipe body, and the restoring capability of the material of the wick structure naturally supports the wick structure at the internal wall of the pipe body;

(b) putting a metal powder into the pipe body, so that the metal powder is attached into the wick structure; wherein the metal powder is made of a pure copper, a copper alloy or a tin material and an appropriate quantity of metal powder is put into the pipe body or sprayed towards the wick structure in the pipe body, and a portion of metal powder is attached onto the wick structure naturally by shaking or rolling the pipe body, and then the excessive metal powder is poured out; and

(c) sintering the metal powder to be used as an adhesive for the pipe body and the wick structure, so that the wick structure can be adhered onto the internal wall of the pipe body by the metal powder, and the fibers of the wick structure can be cohered with each other by the metal powder.

By the foregoing arrangement, the method for adhering the heat pipe wall and the wick can be achieved.

Referring to FIG. 2, the granules of metal powder 3 so formed are finer and will be mixed freely into the meshes or fibers of the wick structure before the sintering process. Therefore, the uneven, discrete, stacked, or loosened granules of powder will not cause an obstruction to the capillary action. After the sintering process is completed, the wick structure 2 can be adhered at the heat pipe wall 1 and the metal powder becomes a good adhesive. Furthermore, the sintered metal powder 3 is a porous structure, that can enhance a capillary transmission for the meshes or fibers of the wick structure 2, and the fibers of the wick structure 2 can be cohered with each other by the metal powder.

In summation of the above description, the present invention herein enhances the performance than the conventional structure and further complies with the patent application requirements and is submitted to the Patent and Trademark Office for review and granting of the commensurate patent rights.

The present invention are illustrated with reference to the preferred embodiment and not intended to limit the patent scope of the present invention. Various substitutions and modifications have suggested in the foregoing description, and other will occur to those of ordinary skill in the art Therefore, all such substitutions and modifications are intended to be embraced within the scope of the invention as defined in the appended claims.

What is claimed is:

1. A method for adhering a heat pipe wall and a wick structure, comprising the steps of:
(a) preparing a hollow heat pipe body, and placing at least one layer of flexible wick structure at an internal wall of the pipe body;
(b) putting a metal powder into the pipe body, and then supporting the wick structure at an internal wall of the pipe body; and the metal powder is attached into the wick structure; and
(c) sintering the metal powder to be used as an adhesive for the pipe body and the wick structure, thereby the wick structure is adhered onto the internal wall of the pipe body by the metal powder, and fibers of the wick structure are cohered with each other by the metal powder.

2. The method for adhering a heat pipe wall and a wick structure of claim 1, wherein in Step (a), the wick structure is coiled to a size with a diameter that can be placed into the pipe body, and the wick structure is put into an opening end of the pipe body, and the restoring capability of the material of the wick structure supports the wick structure at the internal wall of the pipe body.

3. The method for adhering a heat pipe wall and a wick structure of claim 1, wherein the wick structure of Step (a) comprises a mesh or a fiber.

4. The method for adhering a heat pipe wall and a wick structure of claim 1, wherein the metal powder of Step (a) is sprayed towards the wick structure in the pipe body and put into the pipe body.

5. The method for adhering a heat pipe wall and a wick structure of claim 1, wherein the Step (b) further comprises attaching a portion of the metal powder onto the wick structure naturally by shaking or rolling the pipe body, and pouring excessive metal powder out.

6. The method for adhering a heat pipe wall and a wick structure of claim 1, wherein the metal powder of Step (b) is made of a pure copper, a copper alloy or a tin material.
